(19) United States
(12) Patent Application Publication
(10) Pub. No.: US 2010/0238044 A1
(43) Pub. Date: Sep. 23, 2010

(54) System for recovering energy from power cells

(76) Inventor: Steve Locher, Lafayette, CA (US)

Correspondence Address: KEATY LAW FIRM, LLC, 365 CANAL STREET, Suite 2410, NEW ORLEANS, LA, 70130, US

(21) Appl. No.: 12/381,968

(22) Filed: Mar. 18, 2009

(51) Int. Cl. G08B 23/00; H02J 7/00

(52) U.S. Cl. 340/693.1; 320/103

(57) ABSTRACT

A system and method of recovering unused energy from a source power cell and transferring the recovered energy to a rechargeable target power cell. A controller controls operation of the charging circuit that is coupled between the two power cells for regulating transfer of energy between the two power cells.

### BACKGROUND OF THE INVENTION

The present invention relates to a system for recovering remaining energy from a power cell by draining the remaining power from the power cell into a new power cell.

Many articles of electronic equipment use power cells for batteries as a power source. Some electronic devices use battery packs by virtue of their relatively small size and modular nature. Electronic devices may be hand held, such as for instance cell phones, pagers, while others are relatively large, such as for instance laptop computers, television sets, signs and the like.

Some batteries are disposable, that is they are thrown out after the stored energy is used up, while others have recharging capabilities. In many instances, the users proactively dispose of batteries and battery packs before the battery power runs out in anticipation of the forthcoming extended need. One of such examples is a common advice to change batteries in a smoke detector every six months even though it is conceivable that the batteries will work additional several months. As a consequence, many power cells that have unused energy are thrown out.

Of course, battery consumption can vary greatly, depending upon usage levels within the same time period. However, the wasted stored battery energy can range from 15 to 90%, depending on the type of use and application. The cost and environmental impact of the discarded power cells rises every year, as the industries become more and more dependent on portable electronic devices.

While rechargeable batteries offer a reasonable alternative, it is no secret that many field conditions prevent their use, particularly where municipal AC power is unavailable. As a consequence, rechargeable batteries are limited in their application to those instances where the conditions permit their recharging in a relatively inexpensive and convenient manner.

Currently, the only available and reliable chargers rely on AC and/or DC power supplies, typically from vehicles or generators. Though addressing many of the weight and cost challenges associated with the disposable versions of these batteries, some problems remain, such as the problem of requiring fuel to run the vehicles and generators which recharge the batteries, and the risk of draining a vehicle battery if a portable battery is being charged without the motor running. The lack of an efficient charger is tantamount to having no batteries at all. Solar power and fuel cells have also been tested for battery charging, but both at this time have major drawbacks with lack of mobility, efficiency, and reliability

The present invention contemplates the elimination of drawbacks associated with conventional power cell charging and provision of a system that allows draining of energy from used batteries to charge or recharge another battery.

### SUMMARY OF THE INVENTION

It is, therefore, an object of the present invention to provide a system of recovering energy from a power cell.

It is another object of the present invention to provide a system for recovering unused energy from a power cell and transferring the recovered energy into a rechargeable power cell.

These and other objects of the invention are achieved through a provision of a system and method of recovering unused energy from a source power cell and transferring the recovered energy to a rechargeable target power cell. A controller controls operation of the charging circuit that is coupled between the two power cells for regulating transfer of energy between the two power cells. The target power cell is a rechargeable battery.

### BRIEF DESCRIPTION OF THE DRAWINGS

Reference will now be made to the drawings, wherein like parts are designated by like numerals, and wherein

FIG. 1 is a diagram of the system of the present invention.

FIG. 2 is a front view of the housing, within which electric/electronic components of the invention are positioned.

FIG. 3 is a schematic of one exemplary embodiment of the system of the present invention.

FIG. 4 is a detail schematic of one exemplary embodiment of the system of the present invention.

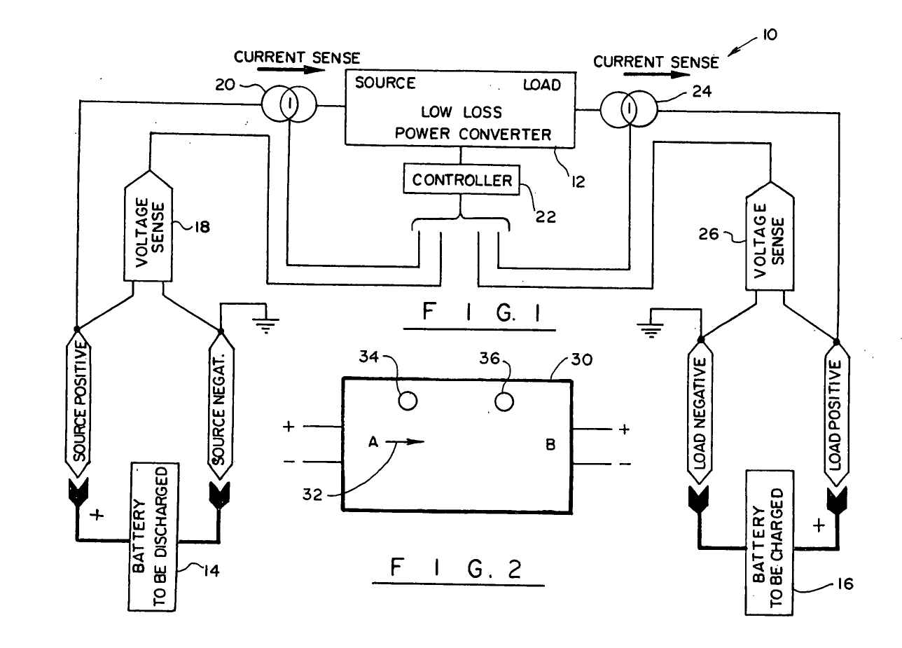

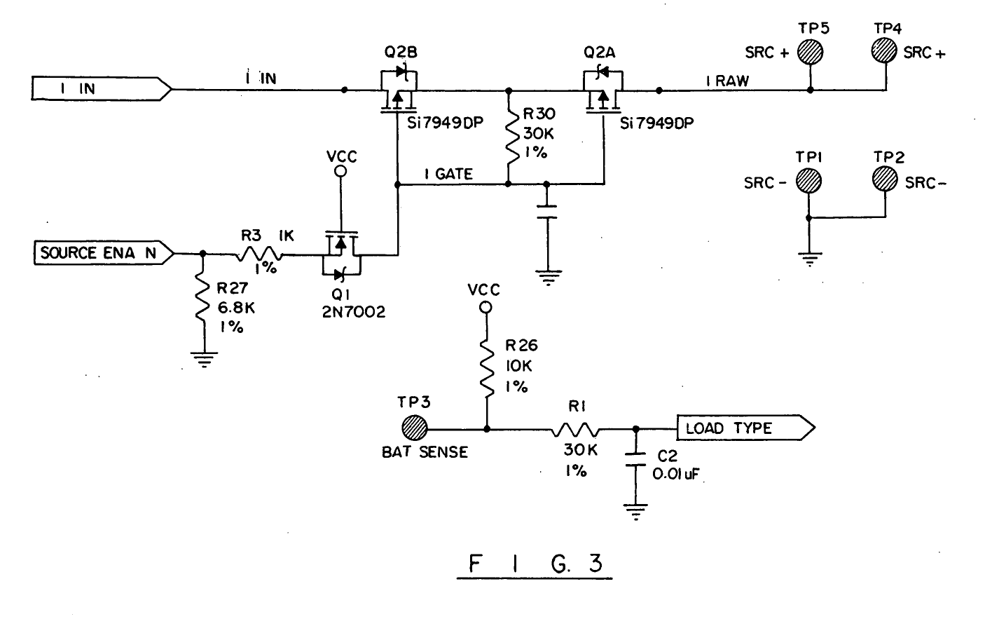

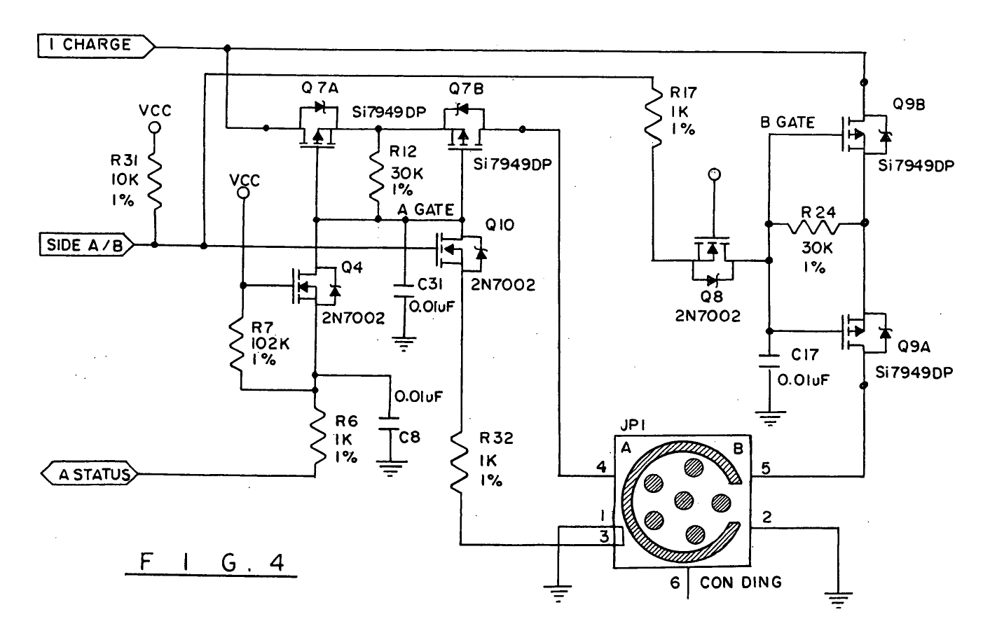

### DETAILED DESCRIPTION OF THE INVENTION

Turning now to the drawings in more detail, numeral 10 designates the system of transferring energy from a power cell according to the present invention. As can be seen in the drawing, the system comprises a charging circuit, or power converter 12 operationally connected between a source battery 14 and a target battery 16. The power converter 12 may be a low loss type power converter that forms a charging circuit for receiving input from the source power cell 14 and transferring the energy to the target power cell 16. The power converter 12 supplies the load power from the source power cell 14 to all electrical and electronic components of the system 10.

The source battery 14 is electrically connected to a voltage regulator 18, which comprises a voltage sense logic module for controlling the voltage regulator 18. The source battery is also connected to an electrical current sensor, or current sense module 20, which is adapted to measure the DC current level in the power cell 14. The current sense module 20 receives current inputs and provides outputs as analog voltage signals, analog current levels, switches, or audible signals. Depending on the selection, the current sense circuit 20 can also provide frequency and modulated frequency outputs. In one aspect of this invention the current sensor 20 is an open loop sensor.

The current sense module 20 is mounted between the source battery 14 and the power converter 12, while the voltage sense module 18 is mounted between the source battery 14 and controller 22. The controller 22 receives signals from both source battery 14 and the target battery 16. The controller 22 processes all monitored signals and provides control stimulus to the power controller 12.

The target battery, or power cell 16 is similarly connected to the power converter 12 through a current sense module 24, which is capable of measuring DC current level in the target power cell 16. An independent voltage sense module 26 is mounted between the target power cell 16 and the controller 22.

The controller 22 provides a means for controlling transfer of power from the source cell 14 to the target cell 16. The controller 22 monitors the source voltage and current, based on the source battery type, so as to determine “end of discharge” for the source power cell 14. The controller 22 also monitors the load voltage and current as well as the load battery type to determine “state of charge” for the target power cell 16.

The controller 22 comprises a microchip DSP processor, which is programmed for the specific batteries used as the source batteries and the target batteries. The power cells 14 and 16 can be AA or AAA batteries or any other type of batteries, depending on specifications. Any type of rechargeable battery can be used, including, but not limited to NiCad, NiMH, and Li-Ion.

The controller 22 also comprises a charge controller circuitry to determine status of the charge process. To help facilitate ease of use, the system 10 can be mounted in a housing 30 with connectors A marked as “power out” and connectors B marked as “power in.” An arrow 32 on the outside of the housing 30 indicates the desired flow of energy direction. An LED indicator light 34 shows the “energy transferring status,” while an LED indicator light 36 shows “energy transfer complete” operational stage of the energy recovery process. Other LED indicator lights may show various operational stages, charging status states, and/or charging error conditions.

The system 10 is not an equilibrium system that is it does not aim to achieve equilibrium in energy capacity between the source battery and the target battery. The system 10 uses the power of the source power cell 14 to completely deplete the energy from the source and transfer the recovered energy to the target power cell 16. The system 10 maximizes the available battery power for the user by collecting the remaining energy of all partially spent, and unusable, batteries and consolidating that power into a rechargeable battery until its charge state is at a usable level once again. The target power cell 16 can be connected to more than one source power cell in order to take advantage of all available partially depleted batteries.

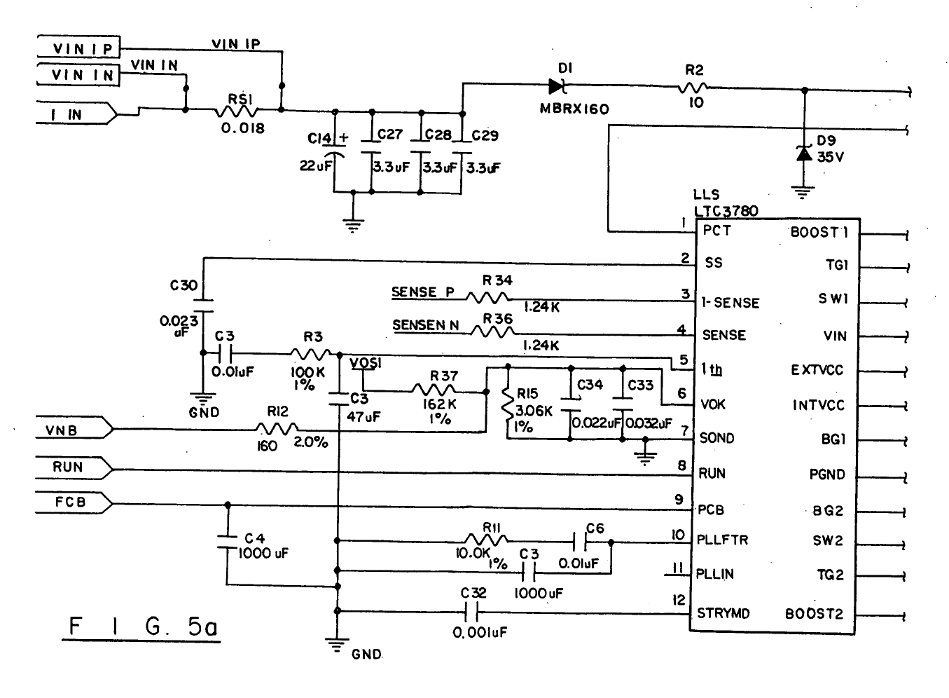

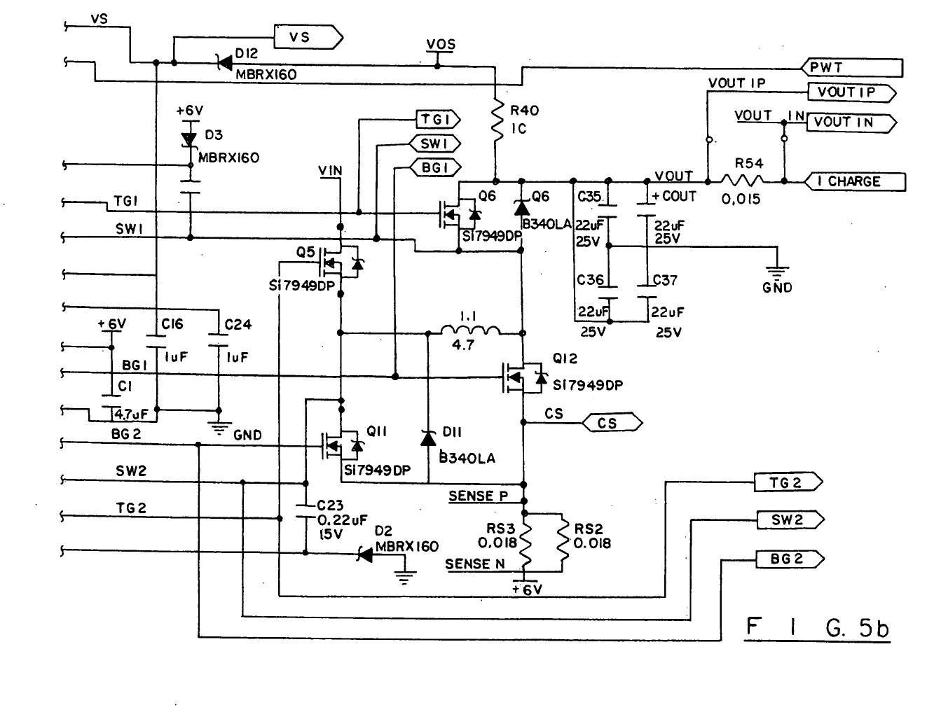

As used herein, “battery” can refer to a single battery, one or more batteries used in series or in parallel arrangement, or any other modular power source. Because the power from the source power cell can be transferred to the target power cell, energy normally lost by discharge of the partially used batteries is saved. The schematic examples illustrated in FIGS. 3 and 4 are for illustration purposes only. It will be understood that the size, capacities, number, and particular layout of the individual switches, capacitors, transistors, etc. will vary due to the individual battery requirements.

The system 10 is a direct-transfer dc-to-dc energy transfer system; it does not use a “holding” step, wherein the recovered energy could be stored until the need arises. In the use of the system 10, a source battery is connected to the target battery immediately through the system 10.

Many changes and modifications can be made in the design of the present invention without departing from the spirit thereof. I, therefore, pray that my rights to the present invention be limited only by the scope of the appended claims.

I claim:

1. A charging system which provides controlled power transfer from a source power cell to a target power cell, comprising: a charging circuit for receiving an input from a source power cell, a charge controller circuit for controlling the operation of said charging circuit, while providing control during routing of energy from said source power cell to the target power cell.

2. The system of claim 1, further comprising a first voltage regulator mounted in operational relationship between the charging circuit and the source power cell and a second voltage regulator mounted between the charging circuit and the target power cell.

3. The system of claim 1, further comprising a current regulator mounted in operational relationship between the charge controller circuit and the source power cell and a second current regulator mounted between the charge controller circuit and the target power cell.

4. The system of claim 1, wherein the target battery is a rechargeable battery.

5. A battery charging unit, comprising a housing, a first external connector secured to the housing and adapted for connecting to a source power cell, a second external connector secured to the housing and adapted for connecting to a target power cell, a charging circuit mounted in the housing and coupled to the source power cell and the target power cell during transfer of energy from the source power cell to the target power cell, and a charge controller circuit mounted in the housing for controlling the operation of said charging circuit, while providing control to transfer energy from the source power cell to the target power cell.

6. The apparatus of claim 5, further comprising at least one visual indicator secured in said housing for indicating status of energy transfer from the source power cell to the target power cell.

7. The apparatus of claim 5, further comprising at least one visual indicator secured in said housing for indicating status of charging capacity of the target power cell.

8. The apparatus of claim 5, further comprising a first voltage regulator mounted in operational relationship between the charging circuit and the source power cell and a second voltage regulator mounted between the charging circuit and the target power cell.

9. The apparatus of claim 5, further comprising a current regulator mounted in operational relationship between the charge controller circuit and the source power cell and a second current regulator mounted between the charge controller circuit and the target power cell.

10. A method of saving power in a battery-powered system comprising a source battery and a target battery, the method comprising a step of transferring remaining energy from a source battery to the target battery, while controlling charging of the target battery.

11. The method of claim 10, wherein said target battery is a rechargeable battery.

12. The method of claim 10, further comprising a step of providing a charging circuit coupled to said source battery and said target battery for facilitating transfer of energy from the source battery to the target battery.

13. The method of claim 12, further comprising a step of providing a controller circuit coupled to said source battery, said target battery and said charging circuit for controlling transfers of energy from the source battery to the target battery.

14. The method of claim 10, wherein said step of transferring energy comprises a step of recovering energy from the source battery.

15. The method of claim 10, further comprising a step of providing a first set of voltage controller and a current controller operationally connectable to the source battery.

16. The method of claim 10, further comprising a step of providing a second set of voltage controller and a current controller operationally connectable to the target battery.

17. The method of claim 10, wherein said target battery is a rechargeable battery.
